(19) United States
(12) Patent Application Publication
(10) Pub. No.: US 2016/0129636 A1
(43) Pub. Date: May 12, 2016

(54) MODIFYING A THREE-DIMENSIONAL OBJECT TO BE PRINTED WITHOUT EXCEEDING A TIME OR COST THRESHOLD

(71) Applicant: Lenovo Enterprise Solutions (Singapore) Pte. Ltd., Singapore (CN)

(72) Inventors: Gary D. Cudak, Wake Forest, NC (US); Christopher J. Hardee, Raleigh, NC (US); Scott E. Schneider, Rolesville, NC (US)

(21) Appl. No.: 14/537,935

(22) Filed: Nov. 11, 2014

(51) Int. Cl. B29C 67/00; G05B 15/02

(52) U.S. Cl. CPC B29C 67/0088; G05B 15/02; B33Y 50/02

(57) ABSTRACT

A method and a computer program product for performing the method are provided. The method includes identifying a data file including parameters for causing a three-dimensional printer to print a three-dimensional model of an object, identifying a total time or total cost threshold for printing the three-dimensional model of the object on the three-dimensional printer, obtaining a unit time or unit cost for one or more resources required for printing, modifying one or more of the parameters of the data file so that the three-dimensional model of the object can be printed without exceeding the time or cost threshold, and causing the three-dimensional printer to print the three-dimensional model of the object using the modified parameters.

### BACKGROUND

1. Field of the Invention

The present invention relates to methods of three-dimensional printing.

2. Background of the Related Art

Three-dimensional (3D) printing is a process of making a three-dimensional object from a digital model using an additive process, where successive layers of material are laid down over previous layers. The material may be a thermoplastic polymer filament that is heated and extruded through a narrow nozzle. In one type of three-dimensional printer, the nozzle, the table supporting the material, or both is moved to control where the material is deposited. Other types of three-dimensional printers may use alternative mechanisms to control the position of a nozzle for dispensing the material.

3D printing is becoming a big industry with a growing number of printer manufacturers and web sites that provide construction plans in the form of a data file for downloading to a computer. Unfortunately, 3D printing is much more complex than 2D printing and requires much more time to produce an object. Objects that are printed at a fine level of detail or are large can take many hours to complete. Ideally, a 3D print job is not started unless there is enough time and materials to complete the job.

### BRIEF SUMMARY

One embodiment provides a method comprising identifying a data file including parameters for causing a three-dimensional printer to print a three-dimensional model of an object, identifying a total time or total cost threshold for printing the three-dimensional model of the object on the three-dimensional printer, obtaining a unit time or unit cost for one or more resources required for printing, modifying one or more of the parameters of the data file so that the three-dimensional model of the object can be printed without exceeding the time or cost threshold, and causing the three-dimensional printer to print the three-dimensional model of the object using the modified parameters.

Another embodiment provides a computer program product comprising a computer readable storage medium having program instructions embodied therewith, wherein the program instructions are executable by a processor to cause the processor to perform the method. The method comprises identifying a data file including parameters for causing a three-dimensional printer to print a three-dimensional model of an object, identifying a total time or total cost threshold for printing the three-dimensional model of the object on the three-dimensional printer, obtaining a unit time or unit cost for one or more resources required for printing, modifying one or more of the parameters of the data file so that the three-dimensional model of the object can be printed without exceeding the time or cost threshold, and causing the three-dimensional printer to print the three-dimensional model of the object using the modified parameters.

### BRIEF DESCRIPTION OF THE SEVERAL VIEWS OF THE DRAWINGS

FIG. 1 is a diagram of a computer controlling a three-dimensional printer.

FIG. 2 is a diagram of an alternative three-dimensional printer.

FIG. 3 is a diagram of a computer according to one embodiment of the present invention.

FIG. 4 is a diagram illustrating one manner of providing user input.

FIGS. 5A-5C are illustrations of a graphical user interface enabling a user to input various data or make various selections in accordance with optional features of the method.

FIG. 6 is a flowchart of a method in accordance with one embodiment of the method.

### DETAILED DESCRIPTION

Embodiments include a method and a computer program product comprising a computer readable storage medium having program instructions embodied therewith, wherein the program instructions are executable by a processor to cause the processor to perform the method. The method comprises identifying a data file including parameters for causing a three-dimensional printer to print a three-dimensional model of an object, identifying a total time or total cost threshold for printing the three-dimensional model of the object on the three-dimensional printer, obtaining a unit time or unit cost for one or more resources required for printing, modifying one or more of the parameters of the data file so that the three-dimensional model of the object can be printed without exceeding the time or cost threshold, and causing the three-dimensional printer to print the three-dimensional model of the object using the modified parameters.

A data file including parameters for causing a three-dimensional printer to print a three-dimensional model of an object may be identified by receiving input from a user. For example, the user may selected the data file from a list of data files stored on, or accessible to, the three-dimensional printer or a computer that is in communication with the three-dimensional printer. A list of data files may be displayed on a graphical user interface, such that that user may select one of the displayed data files using a cursor control device, such as a mouse, track pad or touchscreen.

A total time or total cost threshold for printing the three-dimensional model of the object on the three-dimensional printer may be identified by receiving input from a user. For example, the user may use a keyboard to type a desired value of a total time threshold or a desired value of a total cost threshold into an appropriately labeled entry box of a graphical user interface. In one option, the user may input a total cost value as a monetary value (i.e., $5.00) or a percentage of available material (i.e., 50% of the material remaining available). In another option, the user may input a total time value as a time period (i.e., 1 hour and 15 minutes) or a point in time (i.e., 5:00 pm).

A unit time or unit cost value for one or more resources that are required for printing may be obtained from any one or more sources. Non-limiting examples of how to obtain the unit time or unit cost values include reading vital product data for the three-dimensional printer, analyzing a stored history of print jobs, and receiving user input. A unit time value might, for example, be provided in units of time per unit of mass (i.e., seconds/gram). Accordingly, the mathematical product of the mass of the object and the unit time value yields the amount of time required to print the object. A unit cost value might, for example, be provided in units of currency per unit of mass (i.e., cents/gram). Accordingly, the mathematical product of the mass of the object and the unit cost value yields the amount of cost of material required to print the object. Similarly, a unit cost of energy may be used to calculate the total energy cost of printing the object, where a unit cost of energy may be provided in units of currency per unit of mass printed or currency per unit of time to complete the print job.

The method may further include outputting the one or more modified parameters to a user, and receiving input from the user accepting or rejecting the one or more modified parameters, wherein the three-dimensional printer is caused to print the three-dimensional model of the object using the selected set of modified parameters in response to receiving user input accepting the one or more modified parameters. The output may take any know form, but is preferably a graphical user interface such that the user can use a cursor control device, such as a mouse, to select an “accept” or “reject” button displayed on the interface. The one or more modified parameters may, for example, be selected from a material type, thickness, fine details, texture, and dimensional scale. It should be recognized that changing any or more of these parameters or other parameters of a data file will affect the total time or total cost of printing the three-dimensional model of the object.

Similarly, the method may further include outputting a plurality of sets of the one or more modified parameters to a user, and receiving input from the user selecting one of the sets of the one or more modified parameters, wherein the three-dimensional printer is caused to print the three-dimensional model of the object using the selected set of the one or more modified parameters in response to receiving the user selection. For example, each set of the one or more modified parameters may include one or more modified parameters selected from a material type, thickness, fine details, texture, and dimensional scale. By allowing the user to select from among sets of modified parameters, the user can consider the end use of the object and select which set will be the most acceptable. The user may prefer that fine details be modified (i.e., eliminated) rather than the thickness of the object if the object is a structural component, whereas the user may prefer the thickness of the object to be modified (i.e., made thinner) rather than modify fine details if the object is primarily aesthetic.

Various embodiments of the method may modify the parameters of the data file in certain rule-based manners, such as incremental decreases in wall thickness of the object or incremental decreases in print resolution. Other embodiments may modify the parameters of the data file by selecting from a plurality of predetermined design variations stored in, or in association with, the first data file. For example, a data file for a particular object (i.e., a handle for a new type of tool) may include parameters for a first variation that can be used in reliability testing (i.e., full strength) and modified parameters a second variation that can be used in marketing presentations (i.e., identical appearance, but not full strength).

Certain embodiments are specifically adapted for use in systems having more than one available three-dimensional printer. Accordingly, the method may further include identifying a first three-dimensional printer having a first material type and a second three-dimensional printer having a second material type, wherein the three-dimensional model of the object is printed on the three-dimensional printer having a material type that is specified in the modified parameters. Changing the material type may therefore lead to a selection between the three-dimensional printers. Similarly, the method may further include identifying a first unit cost of energy for the first three-dimensional printer and a second unit cost of energy for the second three-dimensional printer, wherein the three-dimensional model of the object is printed on the three-dimensional printer having a unit cost of energy that allows printing of the three-dimensional model of the object using the modified parameters without exceeding the total cost threshold. In order to reduce the total cost of printing the object, the three-dimensional printer with the lower unit energy cost may be selected. Additionally, the method may further include identifying a first print resolution for the first three-dimensional printer and a second print resolution for the second three-dimensional printer, wherein the three-dimensional model of the object is printed on the three-dimensional printer having a print resolution that allows printing of the three-dimensional model of the object using the modified parameters without exceeding the total time threshold. In other words, a three-dimensional printer with a high resolution may take more time and consume more energy to print an object than another three-dimensional printer having a lower resolution. Accordingly, if the user is more concerned with total cost than resolution and fine detail, then the three-dimensional printer with the lower resolution may be selected.

One optional feature of the method places limits on which parameters of a data file may be modified. For example, where a first data file and a second data file enable printing of component parts of the same device, then the dimensions of the object according to one data file should not be scaled unless the dimensions of the object according to the other data file are also being scaled to the same extent. If one object has already been printed, then the scale of the other object should not be scaled at all. Accordingly, the method may include determining whether the first data file identifies an association with a second data file and, in response to determining that the first data file identifies an association with the second data file, determining one or more parameters of the first data file that may not be modified.

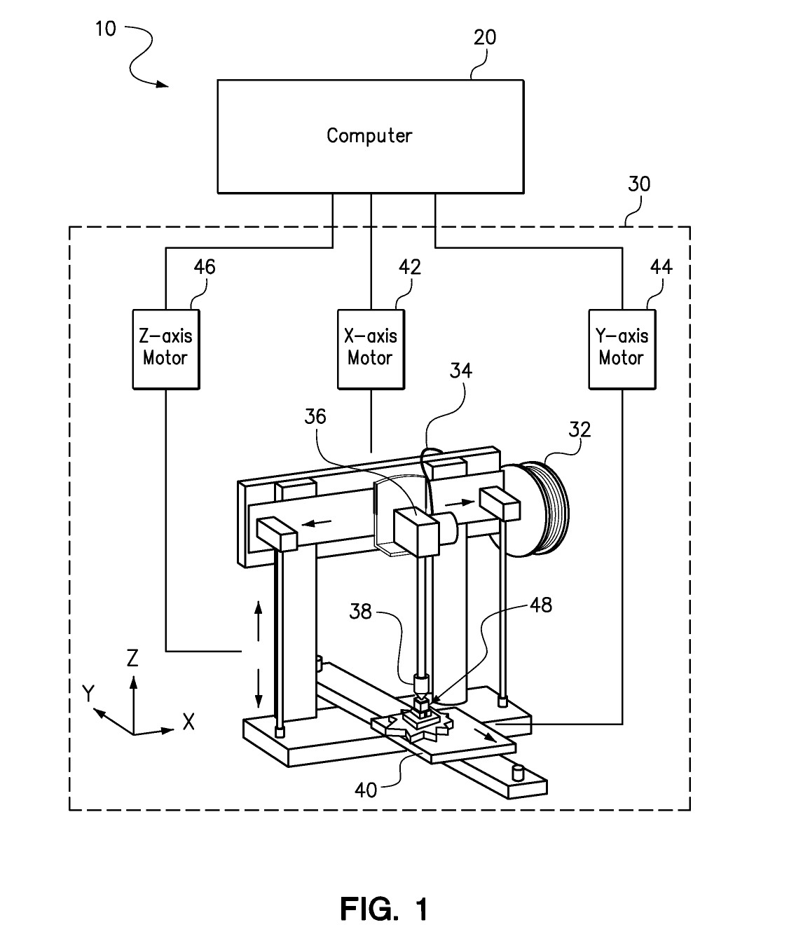

FIG. 1 is a diagram of a system 10 including a computer 20 controlling a three-dimensional printer 30. This three-dimensional printer 30 includes a filament spool 32 for supplying a plastic filament 34 into an extruder 36. The heated plastic is pushed through a nozzle 38 onto a print bed or table 40 where the object is printed. As shown, the object 48 has already received a number of layers of plastic material, such that the nozzle is some distance above the table 40.

The position of the tip of the nozzle 38 determines where a thin layer of the plastic material will be placed. As the plastic passes through the nozzle 38, the nozzle 38 may be moved back and forth along an X-axis by an X-axis motor 42, and the table 40 may be moved back and forth along a Y-axis by a Y-axis motor 44. As each layer has been completed in the X-Y plane, the table may be moved down along a Z-axis by a Z-axis motor 46 so that another layer of the plastic may be applied through the nozzle moving in along the X-axis while the object or work piece is moved along with the table along the Y-axis. The printer also includes structural members that guide the nozzle along the X-axis, guide the table along the Y-axis, and guide the table along the Z-axis. The computer 20 provides instructions to the printer 30 to operate the X-axis motor 42, the Y-axis motor 44, and the X-axis motor 46 in a manner that positions the nozzle 38 where is can progressively build the object.

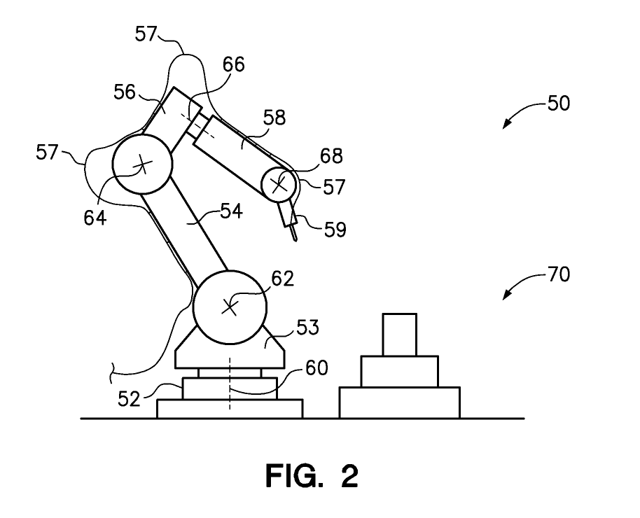

FIG. 2 is a diagram of an alternative three-dimensional printer 50. The 3D printer 50 has a stable base 52 and various arms 54, 56, 58. The base and the arms are pivotally coupled with various axis. For example, the base 52 has a vertical axis 60 so that an upper portion 53 of the base, as well as the entire assembly above the upper portion 53, can rotate. The upper portion 53 of the base and the first arm 54 are pivotally coupled about a first horizontal axis 62, and the first arm 54 is pivotally coupled to the second arm 56 about a second horizontal axis 64. The second arm 56 and the third arm 58 are pivotally coupled about the axis 66, which is perpendicular to the axis 66. Further still, the nozzle 59 is pivotally coupled to the third arm 58 about the axis 68. The pivot angle between each pair of the foregoing components can be independently controlled by a motor receiving control signals from a computer or similar controller. Accordingly, the tip of the nozzle 59 can be positioned to dispense material in three-dimensions and in various angular orientations. In the embodiment shown, the material is delivered to the nozzle 59 through a tube 57 from a material source (not shown). The three-dimensional printer 50 is operated under computer control to position the nozzle 59 to print material to form a three-dimensional model of an object. The flow of material through the nozzle 59 may be controlled by a pump (not shown) and/or a valve (not shown) receiving control signals from the computer.

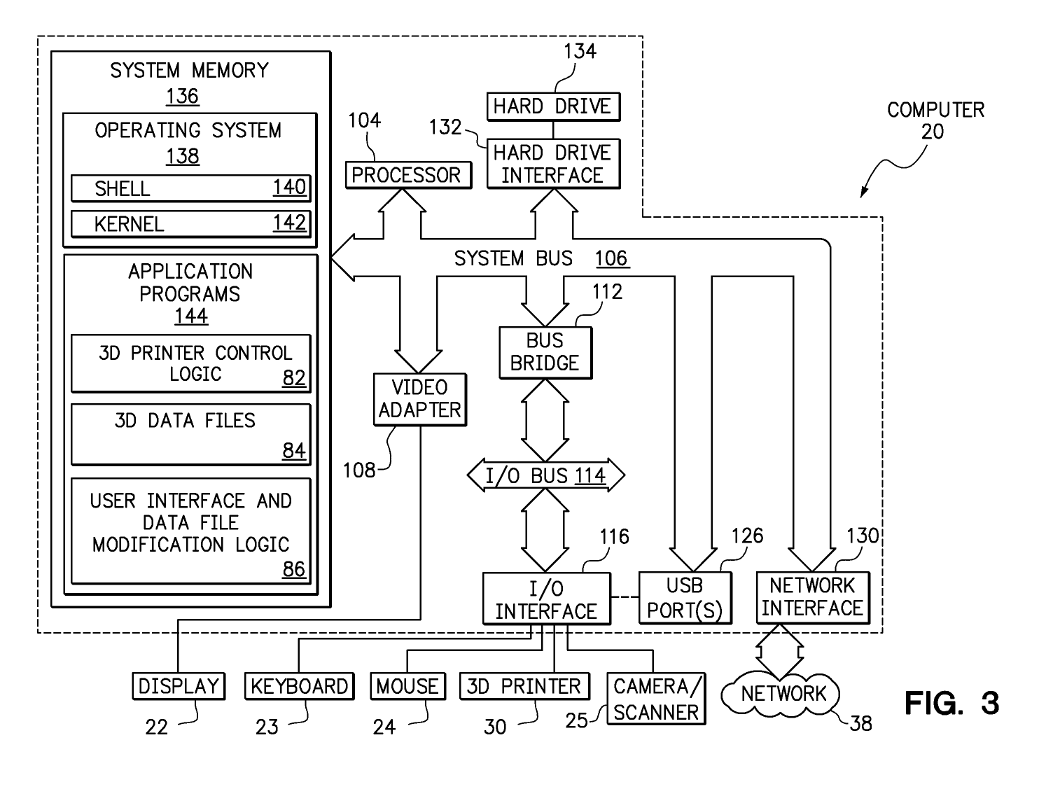

FIG. 3 is a diagram of an exemplary computer 20 that may be used in accordance with one embodiment of the present invention. The computer 20 includes a processor unit 104 that is coupled to a system bus 106. Processor unit 104 may utilize one or more processors, each of which has one or more processor cores. A video adapter 108, which drives/supports a display 22, is also coupled to system bus 106. The system bus 106 is coupled via a bus bridge 112 to an input/output (I/O) bus 114. An I/O interface 116 is coupled to I/O bus 114. I/O interface 116 affords communication with various I/O devices, including a keyboard 23, a mouse 24, a camera or scanner 25 and a 3D printer 30. The I/O devices may optionally include storage devices, such as CD-ROM drives and multi-media interfaces, other printers, and external USB port(s). While the format of the ports connected to I/O interface 116 may be any known to those skilled in the art of computer architecture, in a preferred embodiment some or all of these ports are universal serial bus (USB) ports. As depicted, the computer 20 is able to communicate over a network 38 using a network interface 130. The network 38 may be an external network, such as the global communication network, and perhaps also an internal network such as an Ethernet LAN or a virtual private network (VPN).

A hard drive interface 132 is also coupled to system bus 106 and interfaces with a hard drive 134. In a preferred embodiment, the hard drive 134 populates a system memory 136, which is also coupled to system bus 106. System memory is defined as a lowest level of volatile memory in computer 100. This volatile memory includes additional higher levels of volatile memory (not shown), including, but not limited to, cache memory, registers and buffers. Data that populates system memory 136 includes the computer's operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, the OS 138 also includes a kernel 142, which includes lower levels of functionality for OS 138, including providing essential services required by other parts of OS 138 and application programs 144, including memory management, process and task management, disk management, and mouse and keyboard management. The application programs 144 in the system memory of the computer 20 may include various programs and modules for implementing the methods described herein, such as the 3D printer control (print driver) logic 82, the 3D data files 84, and user interface and dimensional scaling logic 86.

The hardware elements depicted in computer 20 are not intended to be exhaustive, but rather are representative components suitable to perform the processes of the present invention. For instance, computer 20 may include alternate memory storage devices such as magnetic cassettes, digital versatile disks (DVDs), Bernoulli cartridges, and the like. These and other variations are intended to be within the spirit and scope of the present invention.

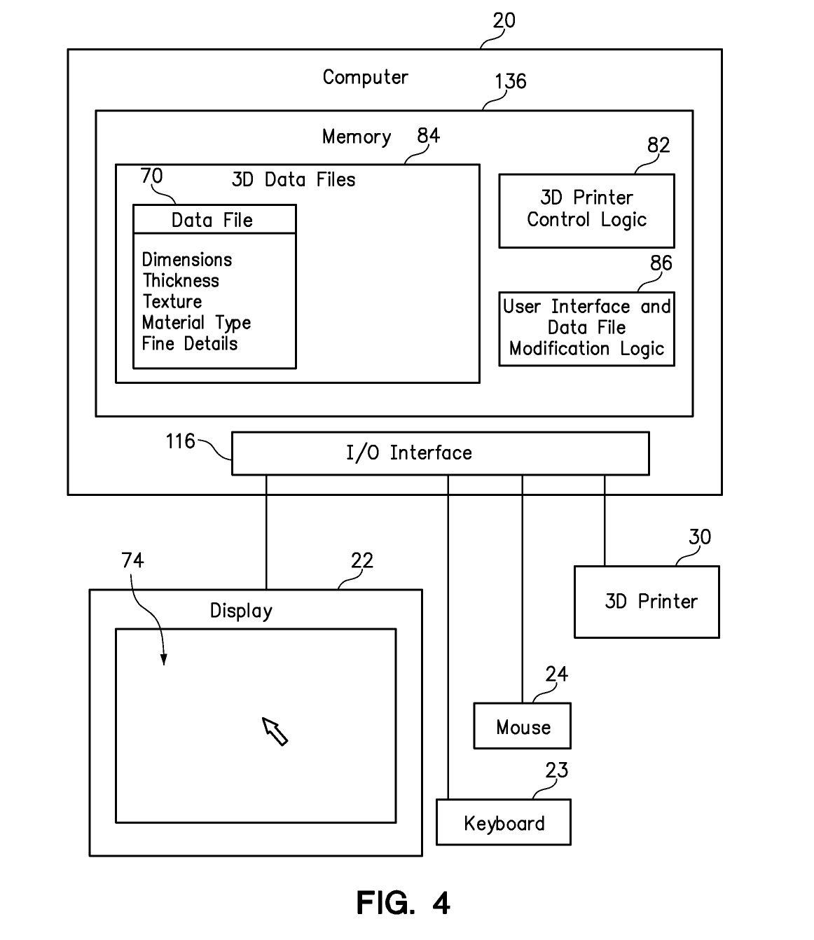

FIG. 4 is a diagram illustrating one manner of providing user input. Consistent with FIG. 3, FIG. 4 shows the computer 20 including memory 136 and an I/O interface 116 that is coupled to a display 22, a keyboard 23, a mouse 24 and the 3D printer 30. Similarly, the memory 136 includes the 3D printer control (print driver) logic 82, the 3D data files 84, and user interface and data file modification logic 86.

The 3D data files 84 include at least a data file 70 including various parameters about an object that may be printed on the three-dimensional printer using the data file. For example, the first data file 70 may include parameters, such as dimensions, thickness, texture, material type, fine details, color, and the like.

The user interface and data file modification logic 86 may generate and display a graphical user interface 74 on the display 22 for the purpose of communicating with the user, such as providing an input form or prompts, and receiving user input. The computer 20 receives user input from the keyboard 23 and/or the mouse 24. Based upon the user input, the user interface and data file modification logic 86 may modify one or more of the parameters of the data file so that the three-dimensional model of the object can be printed without exceeding the time or cost threshold. Using the modified parameters, the 3D printer control logic 82 causes the three-dimensional printer 30 to print the three-dimensional model of the object.

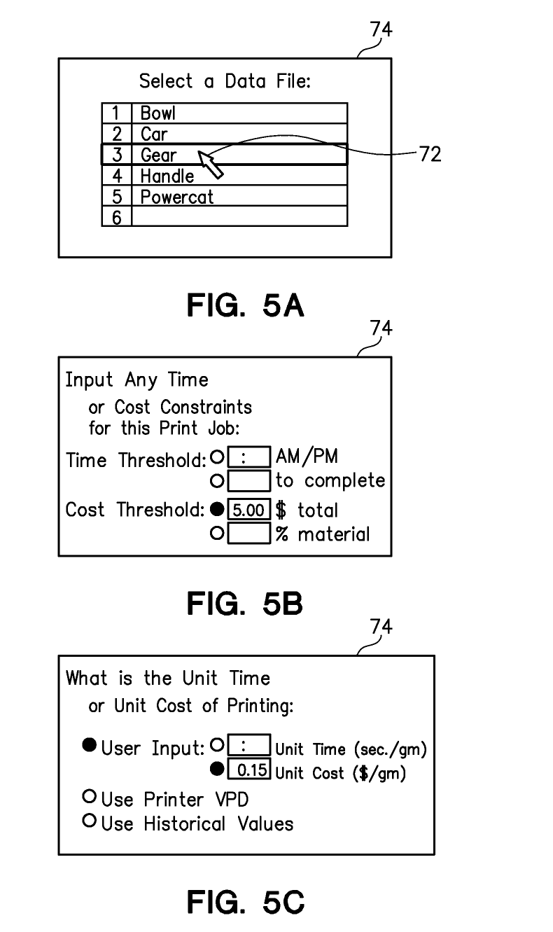

FIGS. 5A-5C are illustrations of a graphical user interface 74 enabling a user to input various data or make various selections in accordance with optional features of the method. In FIG. 5A, the graphical user interface 74 displays a list of data files and prompts the user to select one of the data files. Use a mouse of a track pad, for example, the user can control the position of the cursor 72 over a desired data file and then click to select that data file. In FIG. 5B, the graphical user interface 74 displays a screen for inputting a time threshold and/or a cost threshold. As shown, the user has selected to input a cost threshold of $5.00 total printing cost. In FIG. 5C, the graphical user interface 74 displays a screen allowing the user to identify a desired source of a unit time or unit cost of printing. A shown, the user has selected to provide user input of the unit cost of printing (in units of dollars/grams of material) rather that a unit time (in units of seconds/gram of material). Alternatively, the user might have selected for unit time and unit cost values to be obtained from printer vital product data (VPD) or from historical values of unit time and unit cost.

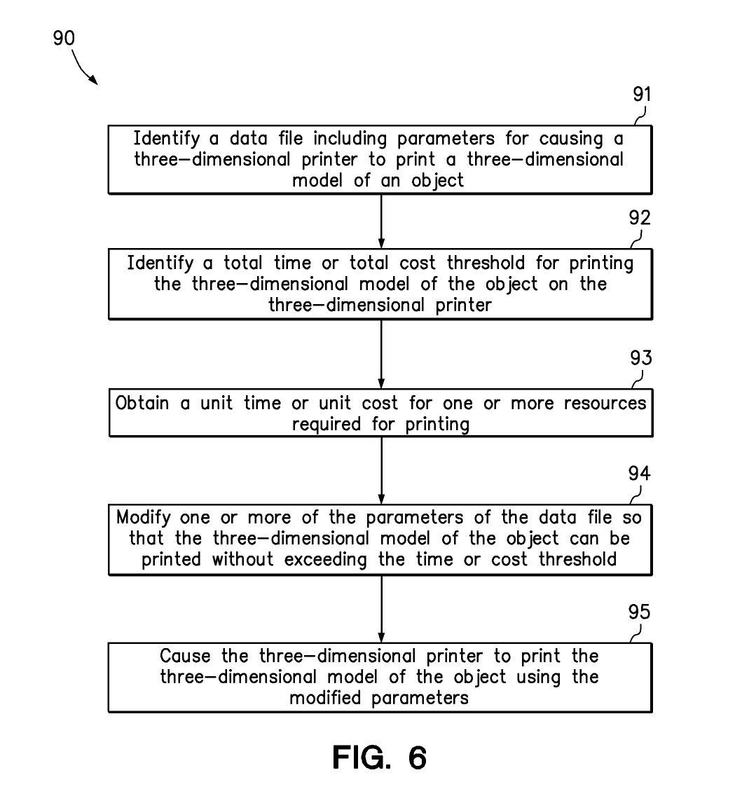

FIG. 6 is a flowchart of a method 90. In step 91, the method identifies a data file including parameters for causing a three-dimensional printer to print a three-dimensional model of an object. In step 92, the method identifies a total time or total cost threshold for printing the three-dimensional model of the object on the three-dimensional printer. In step 93, the method obtains a unit time or unit cost for one or more resources required for printing. One or more of the parameters of the data file are modified in step 94, so that the three-dimensional model of the object can be printed without exceeding the time or cost threshold. In step 95, the three-dimensional printer is caused to print the three-dimensional model of the object using the modified parameters.

The foregoing computer program products may further include computer readable program code for implementing or initiating any one or more aspects of the methods described herein. Accordingly, a separate description of the methods will not be duplicated in the context of a computer program product.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product comprising a computer readable storage medium having program instructions embodied therewith, the program instructions executable by a processor to cause the processor to perform a method comprising:
identifying a data file including parameters for causing a three-dimensional printer to print a three-dimensional model of an object;
identifying a total time or total cost threshold for printing the three-dimensional model of the object on the three-dimensional printer;
obtaining a unit time or unit cost for one or more resources required for printing;
modifying one or more of the parameters of the data file so that the three-dimensional model of the object can be printed without exceeding the time or cost threshold; and
causing the three-dimensional printer to print the three-dimensional model of the object using the modified parameters.

2. The computer program product of claim 1, the method further comprising:
outputting the one or more modified parameters to a user; and
receiving input from the user accepting or rejecting the one or more modified parameters, wherein the three-dimensional printer is caused to print the three-dimensional model of the object using the selected set of modified parameters in response to receiving user input accepting the one or more modified parameters.

3. The computer program product of claim 1, wherein the one or more modified parameters are selected from a material type, thickness, fine details, texture, and dimensional scale.

4. The computer program product of claim 1, the method further comprising:
outputting a plurality of sets of the one or more modified parameters to a user; and
receiving input from the user selecting one of the sets of the one or more modified parameters, wherein the three-dimensional printer is caused to print the three-dimensional model of the object using the selected set of the one or more modified parameters in response to receiving the user selection.

5. The computer program product of claim 4, wherein each set of the one or more modified parameters includes one or more modified parameters selected from a material type, thickness, fine details, texture, and dimensional scale.

6. The computer program product of claim 1, wherein modifying one or more of the parameters of the data file, includes selecting from a plurality of predetermined design variations stored in, or in association with, the first data file.

7. The computer program product of claim 1, further comprising:
identifying a first three-dimensional printer having a first material type and a second three-dimensional printer having a second material type, wherein the three-dimensional model of the object is printed on the three-dimensional printer having a material type that is specified in the modified parameters.

8. The computer program product of claim 1, further comprising:
identifying a first unit cost of energy for the first three-dimensional printer and a second unit cost of energy for the second three-dimensional printer, wherein the three-dimensional model of the object is printed on the three-dimensional printer having a unit cost of energy that allows printing of the three-dimensional model of the object using the modified parameters without exceeding the total cost threshold.

9. The computer program product of claim 1, further comprising:
identifying a first print resolution for the first three-dimensional printer and a second print resolution for the second three-dimensional printer, wherein the three-dimensional model of the object is printed on the three-dimensional printer having a print resolution that allows printing of the three-dimensional model of the object using the modified parameters without exceeding the total time threshold.

10. The computer program product of claim 1, wherein identifying a total time or total cost threshold for printing the three-dimensional model of the object on the three-dimensional printer, includes receiving input from a user.

11. The computer program product of claim 10, wherein the input received from the user includes a total cost, and wherein the total cost is a monetary value or a percentage of available material.

12. The computer program product of claim 10, wherein the input received from the user includes a total time, wherein the total time is a time period or a point in time.

13. The computer program product of claim 1, wherein identifying a data file including parameters for causing a three-dimensional printer to print a three-dimensional model of an object, includes receiving input from a user.

14. The computer program product of claim 1, wherein obtaining a unit time or unit cost for one or more resources required for printing, includes reading vital product data for the three-dimensional printer.

15. The computer program product of claim 1, wherein obtaining a unit time or unit cost for one or more resources required for printing, includes analyzing a stored history of print jobs.

16. The computer program product of claim 1, further comprising:
determining whether the first data file identifies an association with a second data file; and
in response to determining that the first data file identifies an association with the second data file, determining one or more parameters of the first data file that may not be modified.
